(19) United States
(12) Patent Application Publication
(10) Pub. No.: US 2009/0135607 A1
(43) Pub. Date: May 28, 2009

(54) Lighting fixture and method

(75) Inventor: David Carr Holloway, Baldwinsville, NY (US)

Correspondence Address: KING & SPALDING, LLP, 1100 LOUISIANA ST., STE. 4000, ATTN.: IP Docketing, HOUSTON, TX, 77002-5213, US

(73) Assignee: Cooper Technologies Company, Houston, TX (US)

(21) Appl. No.: 11/945,748

(22) Filed: Nov. 27, 2007

(51) Int. Cl. F21S 8/04

(52) U.S. Cl. 362/362

(57) ABSTRACT

Luminaires or lighting fixtures and methods according to which the lighting fixture is suitable for use in a hazardous location. Generally, lighting fixtures comprise a first portion and a second portion coupled to the first portion, wherein only the first portion is explosion proof and/or flameproof. Generally, methods comprise providing a lighting fixture comprising first and second regions and positioning a light source in the first region of the lighting fixture.

### BACKGROUND

The present disclosure relates in general to luminaires or lighting fixtures, and in particular to lighting fixtures suitable for use in hazardous environments, areas or locations.

### BRIEF DESCRIPTION OF THE DRAWINGS

FIG. 1 is a perspective view of a lighting fixture according to an embodiment.

FIG. 2 is a sectional view of the lighting fixture of FIG. 1.

### DETAILED DESCRIPTION

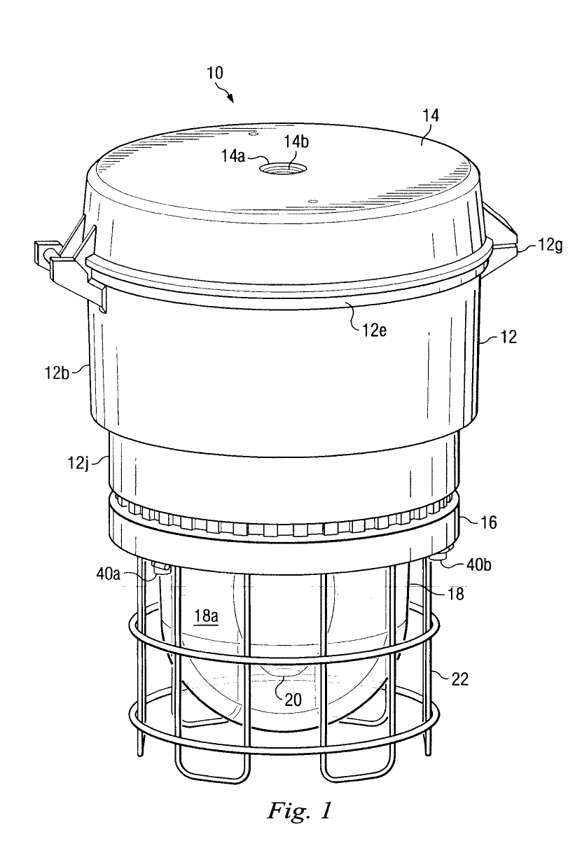

In an exemplary embodiment, as illustrated in FIG. 1, a luminaire or lighting fixture is generally referred to by the reference numeral 10 and includes a ballast housing 12 to which a cover 14 is hingedly connected. A globe holder 16 is connected to the ballast housing 12, and a globe 18 defining a region 18a is coupled to the globe holder 16. A light source, such as a lamp 20, extends within the region 18a and is surrounded by the globe 18, and a guard 22 surrounds the globe 18.

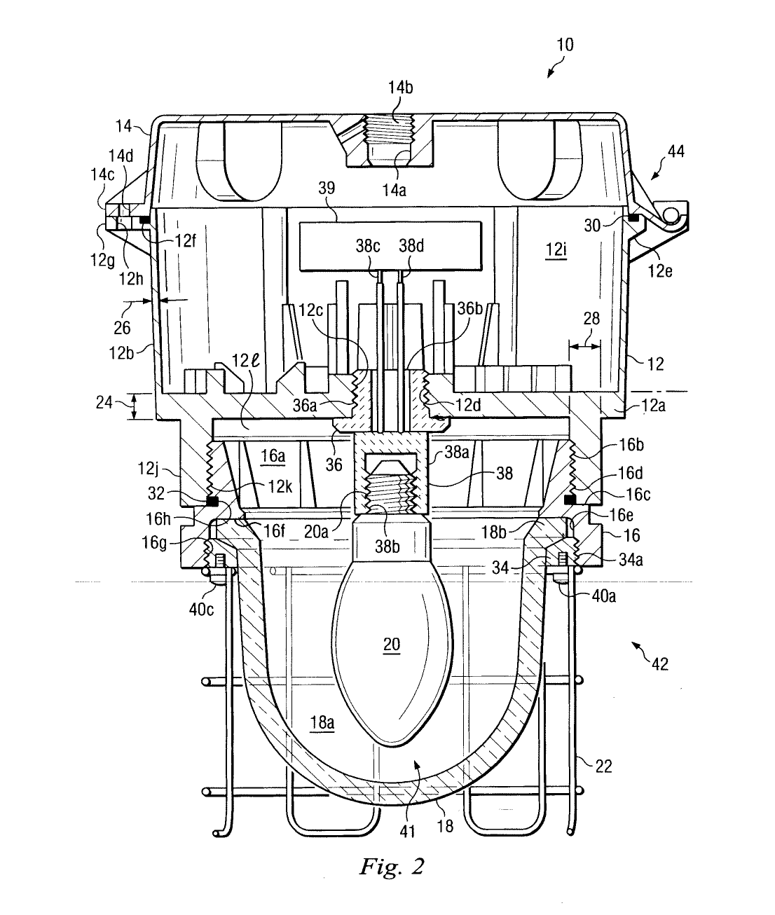

In an exemplary embodiment, as illustrated in FIGS. 1 and 2, the ballast housing 12 includes a horizontally-extending wall 12a and a circumferentially-extending wall 12b that extends upward from the wall 12a. An opening 12c having an internal threaded connection 12d extends through the wall 12a. A lip 12e extends radially outward from wall 12b and a circumferentially-extending channel 12f is formed in the lip 12e. A locking tab 12g extends radially outward from the lip 12e and an opening 12h extends through the tab 12g. A region 12i is defined by the walls 12a and 12b. A circumferentially-extending wall 12j extends downward from the wall 12a and includes an internal threaded connection 12k. A region 12l is defined by the walls 12a and 12j.

The walls 12a, 12b and 12j define thickness dimensions 24, 26 and 28, respectively, with the dimension 26 being less than either of the dimensions 24 or 28. In an exemplary embodiment, the dimensions 24 and 28 may be about equal to one another. In an exemplary embodiment, each of the dimensions 24 and 28 may be greater than or equal to about 0.75 inches. A gasket 30 is disposed in the annular channel 12f of the ballast housing 12.

The cover 14 includes an opening 14a having an internal threaded connection 14b, and a locking tab 14c having an opening 14d extending therethrough. When the cover 14 is in a locked configuration, as shown in FIGS. 1 and 2, the opening 14d of the cover 14 and the opening 12h of the ballast housing 12 are axially aligned and a fastener (not shown) extends through the openings 14d and 12h, thereby locking the cover 14 to the ballast housing 12 and causing the gasket 30 to sealingly engage the cover 14.

The globe holder 16 defines a passage 16a and includes an external annular recess 16b defining an external shoulder 16c and having an external threaded connection 16d, an internal annular recess 16e defining an internal shoulder 16f, an internal threaded connection 16g, and an external annular channel 16h adjacent the external threaded connection 16d. A gasket 32 is disposed in the channel 16h of the globe holder 16. When the lighting fixture 10 is an assembled condition, the external threaded connection 16d of the globe holder 16 is engaged with the internal threaded connection 12k of the ballast housing 12, thereby coupling the globe holder 16 to the ballast housing 12. Moreover, the distal end of the wall 12j abuts the external shoulder 16c, thereby causing the gasket 32 to sealingly engage the inside surface of the wall 12j.

The globe 18 includes a lip 18b and is received by the globe holder 16, extending within the internal annular recess 16e and abutting the internal shoulder 16f. A retaining ring 34 includes an external threaded connection 34a, which is engaged with the internal threaded connection 16g of the globe holder 16 so that the lip 18b of the globe 18 is secured in place between the internal shoulder 16f and the retaining ring 34, thereby coupling the globe 18 to the globe holder 16. The globe 18, the globe holder 16 and the retaining ring 34, and the above-described engagements therebetween, are designed to be generally explosion proof using design techniques known to those of ordinary skill in the art. That is, the globe 18, the assembly of the globe holder 16 and the retaining ring 34, and the above-described engagements therebetween, are each adapted to withstand outwardly-directed forces, generated as a result of elevated pressure levels within the region 18a and/or the passage 16a due to an internal explosion, and the stresses associated therewith, as described in further detail below.

An external threaded connection 36a of a sealing element 36 that defines a passage 36b is engaged with the internal threaded connection 12d, thereby coupling the sealing element 36 to the ballast housing 12.

A lamp holder 38 including a tubular body 38a having an internal threaded connection 38b formed therein, and wires 38c and 38d extending from the tubular body 38a, is coupled to the sealing element 36 in a conventional manner so that the wires 38c and 38d extend through the passage 36b of the sealing element 36 and into the region 12i of the ballast housing 12. A barrier such as, for example, a sealing compound such as, for example, an epoxy such as, for example, a two-part epoxy, is disposed in the passage 36b, sealing the portions of the passage 36b that extend between the outside surfaces of the wires 38c and 38d and the inside surface of the wall of the sealing element 36 defined by the passage 36b, filling the cavity defined by the passage 36b and forming a permanent barrier. As a result of the coupling between the lamp holder 38 and the sealing element 36, and the above-described sealing compound disposed in the passage 36b, a flame path between the region 12i and the region 12l of the ballast housing 12 is substantially prevented from forming, as will be described in further detail below.

The wires 38c and 38d are electrically coupled to an electronic or electrical component, such as a ballast 39, which at least partially extends within the region 12i of the ballast housing 12 and which is represented in block-diagram form in FIG. 2. In several exemplary embodiments, the ballast 39 may be secured to the ballast housing 12 in any conventional manner. In several exemplary embodiments, in addition to, or instead of the ballast 39, one or more other types of devices may at least partially extend within the region 12i of the ballast housing 12 such as, for example, an instant re-strike device, one or more capacitors, one or more circuit boards, one or more power supplies, one or more switches and/or one or more other types of electronic devices or terminals. In several exemplary embodiments, in addition to, or instead of the ballast 39, the wires 38c and/or 38d may be electrically coupled to one or more other types of devices extending within the region 12i. In several exemplary embodiments, in addition to, or instead of the ballast 39, the wires 38c and/or 38d may extend through the opening 14a of the cover 14 and may be electrically coupled to one or more other types of devices that are positioned outside of the ballast housing 12.

The lamp 20 is received by the lamp holder 38 and includes an external threaded connection 20a, which is engaged with the internal threaded connection 38b of the lamp holder 38. As a result, the lamp 20 is electrically coupled to the ballast 39 in a conventional manner via the lamp holder 38 and the wires 38c and 38d. As noted above, the lamp 20 extends within the region 18a and is surrounded by the globe 18. In an exemplary embodiment, the lamp 20 may comprise a high-intensity-discharge (HID) lamp or other light source such as, for example, a high pressure sodium lamp, a pulse start metal halide lamp, a metal halide lamp, a mercury vapor lamp, and/or any combination thereof. In several exemplary embodiments, in addition to, or instead of an HID lamp, the lamp 20 may comprise a wide variety of lamps such as, for example, one or more incandescent lamps, one or more light-emitting diodes, and/or one or more fluorescent lamps.

The guard 22 surrounds the globe 18, as noted above, and is coupled to the retaining ring 34 via circumferentially-spaced fasteners 40a, 40b and 40c and another fastener, which is not shown but is positioned opposite the fastener 40b. The fasteners 40a, 40b and 40c, and the fastener opposing the fastener 40b, extend into and threadably engage the retaining ring 34. In several exemplary embodiments, the guard 22 may be coupled to the retaining ring 34 via a wide variety of conventional fastening devices, components, systems and/or combinations thereof. As shown in FIG. 2, the region 12l of the ballast housing 12, the passage 16a of the globe holder 16 and the region 18a of the globe 18 are all fluidicly coupled to one another. As used herein, the term “fluidic” or “fluidicly” refers to the connection between regions such that an element, such as heat or gas, is capable of flowing between the regions. A region 41 is collectively defined by the region 12l, the passage 16a and the region 18a.

A portion 42 of the lighting fixture 10 is defined by the wall 12a and the sealing element 36, and all of the components, subcomponents and/or regions of the lighting fixture 10 positioned below the wall 12a and the sealing element 36, as viewed in FIG. 2, and therefore includes the walls 12a and 12j and the region 12l of the ballast housing 12, the sealing element 36, the lamp holder 38, the lamp 20, the globe 18, the retaining ring 34, the guard 22, the fasteners 40a, 40b and 40c, the fastener opposing the fastener 40b, and the region 41. The portion 42 is generally explosion proof and/or flame proof, as will be described in further detail below.

A portion 44 of the lighting fixture 10 is defined by all of the components, subcomponents and/or regions positioned above the wall 12a and the sealing element 36, as viewed in FIG. 2, and therefore includes the wall 12b and the region 12i of the ballast housing 12, the respective distal end portions of the wires 38c and 38d, the ballast 39 and the cover 14. The portion 44 is coupled to the portion 42 as a result of the wall 12b, which forms part of the portion 44, extending from and being integrally formed with the wall 12a, which forms part of the portion 42.

When the lighting fixture 10 is in an installed condition, the cover 14 is in its above-described locked configuration and the lighting fixture 10 is mounted to a support bracket or structure such as, for example, a pendant, which is coupled to an overhead support structure such as a ceiling; a wall bracket, which is mounted to a vertically-extending support structure such as a wall; a stanchion, which is mounted to a horizontally-extending support structure such as a floor; a ceiling mounting bracket, which is mounted to an overhead support structure such as a ceiling; and/or any combination thereof. In an exemplary embodiment, to mount this support bracket or structure to the lighting fixture 10, the support bracket or structure may include an external threaded connection that engages the internal threaded connection 14b of the cover 14. Moreover, the ballast 39 is electrically coupled to a source of electrical power. In an exemplary embodiment, the ballast 39 may be electrically coupled to a source of electrical power that is positioned outside of the ballast housing 12, via one or more wires that extend through the opening 14a of the cover 14 and/or through one or more other openings in the ballast housing 12 and/or the cover 14.

In an exemplary embodiment, the lighting fixture 10 is installed in a hazardous environment, area or location such as, for example, a location in which flammable gases or vapors are or may be present in the air in quantities sufficient to produce explosive or ignitable mixtures, a location that is hazardous because of the presence of combustible dust, or a location that is hazardous because of the presence of easily ignitable fibers or flyings.

In operation, electrical power is supplied to the ballast 39 and the ballast 39 and the lamp 20 operate in a conventional manner so that the lamp 20 provides light to the environment surrounding the lighting fixture 10. The ballast 39 controls the operation of the lamp 20.

In some cases, when the lighting fixture 10 is installed in a hazardous location and during the operation of the lighting fixture 10, a supply of oxygen is present within the region 41 of the portion 42. This supply of oxygen may be present as a result of the oxygen content in the air within the region 41. Moreover, sufficient fuel is present in the air within the region 41, and this fuel may be in the form of a gas, vapor, mist and/or dust. As a result of the presence of oxygen and fuel within the region 41, and due in part to the power dissipation of the lamp 20 and the heat generation associated therewith during the operation of the lighting fixture 10, the lamp 20 may serve as an ignition source and an internal explosion may occur within the region 41. In an exemplary embodiment, in addition to, or instead of the lamp 20, the lamp holder 38 may serve as an ignition source due to, for example, the electrical coupling between the lamp holder 38 and the lamp 20, any burn-out or electrical failure of the lamp holder 38, the shorting of an electrical terminal within the lamp holder 38, and/or the breakage of the lamp 20.

As a result of this internal explosion, hot or burning gases are generated within the region 41 and the pressure therein increases significantly. As a result, outwardly directed forces are applied against several parts of the lighting fixture 10, including the wall 12a, the wall 12j, the globe holder 16, the globe 18 and the retaining ring 34. However, as noted above, the globe holder 16, the globe 18 and the retaining ring 34, and the above-described engagements therebetween, are designed to be strong enough to withstand forces generated as a result of an internal explosion both separately and as an assembly, and thus do withstand the outwardly-directed forces and the stresses associated therewith. Moreover, due in part to the increased thickness dimensions 24 and 28 of the walls 12a and 12j, respectively, the walls 12a and 12j, and the engagements between the internal threaded connection 12k and the external threaded connection 16d, and between the internal threaded connection 12d and the external threaded connection 36a of the sealing element 36, also withstand the outwardly directed forces. As a result, the portion 42 is generally explosion proof and/or flameproof, that is, for example, the explosion is generally contained only within the region 41 of the portion 42 so that the explosion does not reach outside of the region 41. For example, the explosion does not reach the region 12i of the ballast housing 12 by rupturing or breaking the wall 12a. For another example, the explosion does not reach the environment surrounding the lighting fixture 10 by rupturing or breaking the globe 18.

In contrast to the portion 42, the portion 44, which includes the wall 12b and the region 12i of the ballast housing 12, the ballast 39 and the cover 14, does not undergo the same outwardly directed forces that are applied to the portion 42. Although the portion 44 may undergo some limited force loading due to the internal explosion within the region 41 of the portion 42, these forces are significantly less than the outwardly-directed forces applied to the components in the portion 42 of the lighting fixture 10. As a result, the structural integrity of the wall 12b of the ballast housing 12 is not significantly compromised, notwithstanding that the dimension 26 is less than each of the dimensions 24 and 28 of the walls 12a and 12j, respectively. Moreover, the portion 44 does not normally undergo an internal explosion because there is no significant ignition source present within region 12i and/or beneath the cover 14, and the wall 12a and the sealing element 36 separate the region 12i from the lamp 20 and the lamp holder 38, each of which may serve as an ignition source as discussed above. As a result, there is no significant pressure build-up in the region 12i of the ballast housing 12 and/or underneath the cover 14. As a result, the portion 44 of the lighting fixture 10 is not designed to be generally explosion proof and/or flameproof and the dimension 26 of the wall 12b is adequate to generally maintain its structural integrity during the operation of the lighting fixture 10, including during an internal explosion in the region 41 of the portion 42, notwithstanding that the dimension 26 is less than each of the dimensions 24 and 28 of the walls 12a and 12j, respectively.

As another result of the above-described internal explosion that occurs within the region 41, the generated hot or burning gases escape out of the portion 42, that is, out of the region 41 using one or more flame paths in the portion 42. These one or more flame paths may include, for example, a flame path between the internal threaded connection 12k and the external threaded connection 16d, and subsequently between the gasket 32 and the inside surface of the wall 12j, and subsequently between the external shoulder 16c and the distal end of the wall 12j.

However, the above-described flame paths of the portion 42 are configured so that the hot or burning gases escaping therealong are cooled to the point that they are too cool to ignite the surrounding atmosphere once they escape; that is, the hot or burning gases do eventually escape out of the portion 42, but only after they have been cooled off and/or their flames quenched. More particularly, the changes in direction associated with the flame path between the internal threaded connection 12k and the external threaded connection 16d are sufficient to cool any gas that escapes out of the portion 42 via this flame path.

One or more of the coupling between the sealing element 36 and the ballast housing 12, the coupling between the lamp holder 38 and the sealing element 36, and the above-described barrier of sealing compound disposed in the passage 36b, generally fluidicly isolate the region 12i from the region 12l, and thus from the region 41, and the hot or burning gases do not generally enter the region 12i of the ballast housing 12 from the region 41.

As a result of the above-described flame paths, which cool the gases escaping out of the region 41, and the above-described fluidic isolation between the regions 12i and 41, the hot or burning gases generated as a result of an internal explosion in the region 41 of the portion 42 do eventually escape out of the portion 42, but only after they have been cooled off and/or their flames quenched so that the temperature of the gases are less than the ignition temperature of the surrounding atmosphere or environment. As a result, the portion 42 is generally explosion proof and/or flameproof, that is, for example, the explosion is generally contained only within the region 41 of the portion 42 so that an ignition does not occur outside of the region 41. For example, an ignition does not occur in the region 12i of the ballast housing 12. For another example, an ignition does not occur in the environment surrounding the lighting fixture 10.

In contrast to the portion 42, flame paths are generally not present in the portion 44, which includes the wall 12b and the region 12i of the ballast housing 12, the ballast 39 and the cover 14, because hot or burning gases leading to ignition are not generated in the region 12i of the ballast housing 12 and/or beneath the cover 14, either as a result of the operation of the ballast 39 within the region 12i or of the operation of the lamp 20 and/or the lamp holder 38 in the region 41. As a result, the portion 44 of the lighting fixture 10 is not designed to be generally explosion proof and/or flameproof.

Since, as described above, the portion 44 of the lighting fixture is neither explosion proof nor flameproof, the design of the portion 44, including the size of the dimension 26 of the wall 12b of the ballast housing 12, is determined without the requirement that the portion 44 be explosion proof and/or flameproof. As a result, and as noted above, the dimension 26 is less than the dimensions 24 and 28 of the walls 12a and 12j, respectively, of the ballast housing 12. Similarly, other dimensions and/or structural design considerations in connection with the portion 44 may be determined without the requirement that the portion 44 be explosion proof and/or flameproof. As a result, the amount of material used to manufacture the portion 44, including the wall 12b of the ballast housing 12 and the cover 14, may be optimized or minimized (if applicable). If the amount of material used to manufacture the portion 44 is so minimized, the cost to manufacture the lighting fixture 10 is reduced. Moreover, the overall weight of the lighting fixture 10 is decreased, thereby reducing the overall cost of, and/or facilitating the ease of, operation (heat transfer), manufacturing, assembling, transporting, installing and/or maintaining the lighting fixture 10.

As described above, the portion 42 of the lighting fixture 10 is generally explosion proof and/or flameproof. As a result, the portion 42 is configured and suitable for use in an environment, area or location that is normally hazardous due to, for example, the presence or likely presence of flammable gases or vapors in the air in quantities sufficient to produce explosive or ignitable mixtures, the presence of combustible dust, or the presence of easily ignitable fibers or flyings.

In an exemplary embodiment, the portion 42 of the lighting fixture 10 is configured and suitable for use in an environment, area or location that is generally classified or known as a Division 1 location, as defined by, for example, Articles 500-503 of the National Electric Code (NEC), that is, a location that is normally hazardous. This Division 1 location may be normally hazardous by virtue of being a Class I, Class II or Class III location, as defined by, for example, Articles 500-503 of the NEC, that is, a location in which flammable gases or vapors are or may be present in the air in quantities sufficient to produce explosive or ignitable mixtures; a location that is hazardous because of the presence of combustible dust; or a location that is hazardous because of the presence of easily ignitable fibers or flyings, but in which such fibers or flyings are not likely to be in suspension in the air in quantities sufficient to produce ignitable mixtures, respectively.

In an exemplary embodiment, the portion 42 of the lighting fixture 10 is configured and suitable for use in an environment, area or location that is generally classified or known as a Zone 1 location as defined by, for example, publication 79-10 of the International Electro-Technical Commission (IEC), that is, a location in which explosive gas atmospheres are likely to occur in normal operation; or a location in which explosive gas atmospheres may exist frequently because of repair or maintenance operations or because of leakage; or a location that is adjacent to a location in which explosive gas atmospheres are present continuously or are present for long periods and from which explosive gas atmospheres could be communicated, with the term “explosive gas atmosphere” generally referring to a mixture with air, under atmospheric conditions, of flammable substances in the form of gas, vapor, or mist in which, after ignition, combustion spreads throughout the unconsumed mixture.

As described above, the portion 44 of the lighting fixture 10 is neither generally flameproof nor generally explosion proof. As a result, the portion 44 is configured and suitable for use in an environment or location that is not normally hazardous. In an exemplary embodiment, the portion 44 is suitable for use in an environment, area or location that is generally classified or known as a Class I Division 2 location as defined by, for example, Articles 500-503 of the NEC, that is, a location that is not normally hazardous, that is, a location in which gases and vapors, dusts, easily ignitable fibers or flyings, or other ignitable materials are not normally present.

In an exemplary embodiment, the portion 44 of the lighting fixture 10 is configured and suitable for use in an environment, area or location that is generally classified or known as a Zone 2 location as defined by, for example, publication 79-10 of the IEC, that is, a location in which explosive gas atmospheres are not likely to occur in normal operation and if they do occur they will exist for a short time only; or a location in which flammable volatile liquids, flammable gases or vapors are handled, processed, or used, but in which liquids, gases or vapors are normally confined within closed containers or closed systems from which they can escape only as a result of accidental rupture or breakdown of the containers or systems or the abnormal operation of the equipment by which the liquids or gases are handled, processed or used; or explosive gas atmospheres are normally prevented by adequate ventilation by which may occur as a result of failure or abnormal operation of the ventilation system; or the location is adjacent to an above-described Zone 1 location from which explosive gas atmospheres could be communicated, unless such communication is prevented by adequate positive-pressure ventilation from a source of clean air, and effective safeguards against ventilation failure are provided, with the term “explosive gas atmosphere” generally referring to a mixture with air, under atmospheric conditions, of flammable substances in the form of gas, vapor, or mist in which, after ignition, combustion spreads throughout the unconsumed mixture.

However, notwithstanding the configuration and suitability of the portion 44 for use in an environment or location that is not normally hazardous, and/or in a Division 2 location, and/or in a Zone 2 location, the portion 44 may still be coupled to the portion 42 and the entire lighting fixture 10 may be used in an environment or location that is normally hazardous, and/or in a Division 1 location, and/or in a Zone 1 location, and/or in a location by permission of a prevailing code or variance, because a significant ignition source is not present within the portion 44, and because the components which may function as an significant ignition source, such as, for example, the lamp 20, are only present within the region 41 of the portion 42, which is fluidicly isolated from the region 12i of the portion 44. In several exemplary embodiments, in addition to, or instead of an environment or location that is normally hazardous, and/or in a Division 1 location, and/or in a Zone 1 location, the lighting fixture 10 may be used in a Division 2 location and/or in a Zone 2 location. Moreover, in several exemplary embodiments, the lighting fixture 10 may be used in a wide variety of environments or locations such as, for example, a non-hazardous location and/or a location that is not normally hazardous.

A lighting fixture has been described that includes a first portion; and a second portion coupled to the first portion; wherein, of the first and second portions, only the first portion is generally explosion proof. In an exemplary embodiment, of the first and second portions, only the first portion is generally configured for use in a normally hazardous location. In an exemplary embodiment, the first portion comprises one or more flame paths. In an exemplary embodiment, of the first and second portions, only the first portion is generally configured for use in a Division 1 location. In an exemplary embodiment, the second portion is generally configured for use in a Division 2 location. In an exemplary embodiment, of the first and second portions, only the first portion is generally configured for use in a Zone 1 location. In an exemplary embodiment, the second portion is generally configured for use in a Zone 2 location. In an exemplary embodiment, the first portion comprises a first region; and a light source at least partially positioned in the first region. In an exemplary embodiment, the second portion comprises a second region; and a component at least partially positioned in the second region and electrically coupled to the light source. In an exemplary embodiment, the second portion further comprises a first wall at least partially surrounding the component and at least partially defining the second region, the first wall defining a first thickness dimension; wherein the first portion further comprises a second wall coupled to the first wall, the second wall extending between and at least partially defining the first and second regions, the second wall defining a second thickness dimension; and wherein the second thickness dimension is greater than the first thickness dimension.

A lighting fixture has been described that includes a first portion comprising a first region; and a light source at least partially positioned in the first region; and a second portion coupled to the first portion, the second portion comprising a second region; and a component at least partially positioned in the second region and electrically coupled to the light source; wherein the second portion further comprises a first wall at least partially surrounding the component and at least partially defining the second region, the first wall defining a first thickness dimension; wherein the first portion further comprises a second wall coupled to the first wall, the second wall extending between and at least partially defining the first and second regions, the second wall defining a second thickness dimension; wherein the second thickness dimension is greater than the first thickness dimension; wherein, of the first and second portions, only the first portion is generally explosion proof and/or flameproof; wherein the first portion comprises one or more flame paths; wherein, of the first and second portions, only the first portion is generally configured for use in a Division 1 location; wherein, of the first and second portions, only the first portion is generally configured for use in a Zone 1 location; wherein the second portion is generally configured for use in a Division 2 location; and wherein the second portion is generally configured for use in a Zone 2 location.

A method has been described that includes providing a lighting fixture comprising first and second regions; positioning a light source in the first region of the lighting fixture; and if an explosion occurs within the first region, containing the explosion only within the first region so that the explosion does not reach outside of the first region. In an exemplary embodiment, the method comprises if the explosion occurs within the first region, containing the explosion only within the first region so that an ignition does not occur outside of the first region. In an exemplary embodiment, containing the explosion only within the first region so that an ignition does not occur outside of the first region comprises fluidicly isolating the second region from the first region. In an exemplary embodiment, an environment surrounds the lighting fixture; and wherein containing the explosion only within the first region so that an ignition does not occur outside of the first region comprises providing one or more flame paths between the first region and the environment. In an exemplary embodiment, the method comprises providing light in a normally hazardous location using the light source. In an exemplary embodiment, the method comprises providing light in a Division 1 location using the light source. In an exemplary embodiment, the method comprises providing light in a Zone 1 location using the light source. In an exemplary embodiment, containing the explosion only within the first region so that the explosion does not reach outside of the first region comprises withstanding one or more outwardly-directed forces generated in the first region as a result of the explosion. In an exemplary embodiment, the method comprises controlling the operation of the light source. In an exemplary embodiment, controlling the operation of the light source comprises positioning a component at least partially within the second region; and electrically coupling the component to the light source. In an exemplary embodiment, positioning a component at least partially within the second region comprises at least partially surrounding the component with a first wall defining a first thickness dimension, the first wall at least partially defining the second region; and wherein containing the explosion only within the first region so that the explosion does not reach outside of the first region comprises providing a second wall defining a second thickness dimension, the second wall being coupled to the first wall and extending between and at least partially defining the first and second regions, the second thickness dimension being greater than the first thickness dimension.

A method has been described that includes providing a lighting fixture comprising first and second regions, wherein an environment surrounds the lighting fixture; positioning a light source in the first region of the lighting fixture; if an explosion occurs within the first region, containing the explosion only within the first region so that the explosion does not reach outside of the first region, comprising withstanding one or more outwardly-directed forces generated in the first region as a result of the explosion; if the explosion occurs in the first region, containing the explosion only within the first region so that an ignition does not occur outside of the first region, comprising fluidicly isolating the second region from the first region; and providing one or more flame paths between the first region and the environment; providing light in a normally hazardous location using the light source; and controlling the operation of the light source, comprising positioning a component at least partially within the second region, comprising at least partially surrounding the component with a first wall defining a first thickness dimension, the first wall at least partially defining the second region; and electrically coupling the component to the light source; wherein containing the explosion only within the first region so that the explosion does not reach outside of the first region further comprises providing a second wall defining a second thickness dimension, the second wall being coupled to the first wall and extending between and at least partially defining the first and second regions, the second thickness dimension being greater than the first thickness dimension.

It is understood that variations may be made in the foregoing without departing from the scope of the disclosure. For example, instead of, or in addition to the wall 12b extending from and being integrally formed with the wall 12a, the portion 44 may be coupled to the portion 42 using, for example, one or more fasteners, fastening systems and/or intervening parts such as one or more mounting brackets. Moreover, the portion 44 may be coupled to the portion 42 by coupling the wall 12b to the wall 12a using, for example, one or more fasteners, fastening systems and/or intervening parts such as one or more mounting brackets. Furthermore, portion 44 may further include ballast components, transformers, power supplies, capacitors, igniters, or pertinent components that may aid in decreasing the cost of producing the lighting fixture 10. Also, other components may be added to the lighting fixture 10 such as, for example, one or more dome reflectors, one or more angle reflectors, and/or one or more refractors. Further, the lighting fixture 10 may be installed in a wide variety of other settings, and in a wide variety of other manners such as, for example, being coupled to a support structure without mounting the lighting fixture 10 to an intermediate support bracket or structure. Still further, one or more additional lamps may be included in the lighting fixture 10.

In several exemplary embodiments, in addition to, or instead of the lamp 20, the lighting fixture 10 may include a wide variety of other light sources. In an exemplary embodiment, the lamp 20 may be a high-intensity-discharge (HID) lamp to which the ballast 39 is electrically coupled. In an exemplary embodiment, the lamp 20 may be an induction lamp to which a generator is electrically coupled, the generator extending within the region 12i of the ballast housing 12. In several exemplary embodiments, the lamp 20 may be, for example, an induction lamp, a high pressure sodium lamp, a pulse start metal halide lamp, a metal halide lamp, a mercury vapor lamp, an incandescent lamp, a fluorescent lamp and/or any combination thereof. In several exemplary embodiments, in addition to, or instead of the ballast 39, a wide variety of electronic or electrical components may extend within the region 12i of the ballast housing 12 and be electrically coupled to the lamp 20, including, for example, one or more generators.

Any spatial references such as, for example, “upper,” “lower,” “above,” “below,” “between,” “vertical,” “angular,” “upward,” “downward,” “side-to-side,” “left-to-right,” “right-to-left,” “top-to-bottom,” “bottom-to-top,” etc., are for the purpose of illustration only and do not limit the specific orientation or location of the structure described above.

In several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several exemplary embodiments have been described in detail above, those skilled in the art will readily appreciate that many other modifications, changes and/or substitutions are possible in the exemplary embodiments without materially departing from the novel teachings and advantages of the present disclosure. Accordingly, all such modifications, changes and/or substitutions are intended to be included within the scope of this disclosure as defined in the following claims. In the claims, means-plus-function clauses are intended to cover the structures described herein as performing the recited function and not only structural equivalents, but also equivalent structures.

What is claimed is:

1. A lighting fixture comprising:
a first portion; and
a second portion coupled to the first portion;
wherein, of the first and second portions, only the first portion is explosion proof, flameproof, or both.

2. The lighting fixture of claim 1, wherein the first portion comprises a first region and a light source at least partially positioned in the first region.

3. The lighting fixture of claim 2, wherein the second portion comprises a second region and a component at least partially positioned in the second region and electrically coupled to the light source.

4. The lighting fixture of claim 3, wherein the second portion further comprises a first wall at least partially surrounding the component and at least partially defining the second region, the first wall defining a first thickness dimension.

5. The lighting fixture of claim 4, wherein the first portion further comprises a second wall coupled to the first wall, the second wall extending between and at least partially defining the first and second regions, the second wall defining a second thickness dimension.

6. The lighting fixture of claim 5, wherein the second thickness dimension is greater than the first thickness dimension.

7. The lighting fixture of claim 1, wherein the first portion comprises one or more flame paths.

8. The lighting fixture of claim 1, wherein, of the first and second portions, only the first portion is configured for use in a Division 1 location.

9. The lighting fixture of claim 1, wherein, of the first and second portions, only the first portion is configured for use in a Zone 1 location

10. The lighting fixture of claim 1, wherein the second portion is configured for use in a Division 2 location.

11. The lighting fixture of claim 1, wherein the second portion is configured for use in a Zone 2 location.

12. A method comprising:
providing a lighting fixture comprising first and second regions; wherein, of the first and second regions, only the first region is explosion proof, flameproof, or both; and
positioning a light source in the first region of the lighting fixture.

13. The method of claim 12, wherein an environment surrounds the lighting fixture.

14. The method of claim 12, wherein if an explosion occurs within the first region, the explosion is contained only within the first region so that the explosion does not reach outside of the first region.

15. The method of claim 14, wherein if an explosion occurs within the first region, containing the explosion only within the first region so that the explosion does not reach outside of the first region, comprises: fluidicly isolating the second region from the first region; and providing one or more flame paths between the first region and the environment.

16. The method of claim 12, comprising providing light in a normally hazardous location using the light source.

17. The method of claim 12, comprising controlling the operation of the light source.

18. The method of claim 17, comprising positioning a component at least partially within the second region, comprising at least partially surrounding the component with a first wall defining a first thickness dimension, the first wall at least partially defining the second region.

19. The method of claim 18, further comprising electrically coupling the component to the light source.

20. The method of claim 18, further comprising providing a second wall defining a second thickness dimension, the second wall being coupled to the first wall and extending between and at least partially defining the first and second regions.

21. The method of claim 20, wherein the second thickness dimension is greater than the first thickness dimension.
